(19) United States
(12) Patent Application Publication
(10) Pub. No.: US 2007/0288571 A1
(43) Pub. Date: Dec. 13, 2007

(54) Method and device for the production and distribution of messages directed at a multitude of recipients in a communications network

(75) Inventor: Joachim Charzinski, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Nokia Siemens Networks GmbH & Co. KG

(21) Appl. No.: 11/810,976

(22) Filed: Jun. 7, 2007

(30) Foreign Application Priority Data
Jun. 7, 2006 (DE) 102006026484.3

(51) Int. Cl. G06F 15/16

(52) U.S. Cl. 709/204

(57) ABSTRACT

A method and a device for the production and distribution of messages directed at a multitude of recipients in a communications network, wherein a message to be transmitted is characterized by at least one semantic feature that defines the content of the meaning of the message, and a number of formal features that define the form of the message, and wherein a multitude of versions of this message are produced for the message to be transmitted, wherein each version of the message differs to a certain degree from other versions of the message with respect to the formal features, and wherein each version of the message is sent to at least one recipient.

### CROSS REFERENCE TO RELATED APPLICATIONS

This application claims priority of German application No. 102006026484.3 DE filed Jun. 7, 2006, which is incorporated by reference herein in its entirety.

### FIELD OF INVENTION

The invention relates to a method and a device for the production and distribution of messages directed at a multitude of recipients in a communications network, whereby steps are taken to prevent such messages from being rejected.

### BACKGROUND OF INVENTION

The distribution of messages in electronic communications networks represents an attractive method for advertisers, for example, because easy and convenient access to electronic media enables messages to be broadcast to a large number of recipients with generally limited expenditures of time and money. A familiar form of messages sent in large numbers is so-called spam: spam is the dispatch of large numbers of unsolicited messages, emails for example. In addition to email spam, other forms of spam exist for instance like spam relating to instant messaging, Usenet newsgroups, www search engines, web logs or wireless communications.

A series of mechanisms for rejecting unsolicited bulk messages exists. For example, email programs are usually in a position to detect such messages. In addition, internet service providers usually offer fee-based services for protecting against spam, which prevent the delivery of unsolicited emails, for example.

### SUMMARY OF INVENTION

With the increasing prevalence of internet telephony (voice over IP, VoIP for short), there are new ways for advertisers to distribute messages. At present, telemarketing calls to conventional PSTN subscribers (PSTN for public switched telephone network) are normally always charged to the caller. In contrast, calls to VoIP subscribes can be made at almost no cost to the caller as a result of the different billing model, which is advantageous for advertisers. The option of sending large numbers of recorded speech files using automated calling machines, for example, could be of interest to advertisers.

As with spam, it is to be assumed that unsolicited calls (so-called SPIT for spam over internet telephony) will increase for VoIP, such that VoIP providers will take appropriate measures to prohibit SPIT calls in order to protect VoIP subscribers from unsolicited calls.

For example, it is possible to identify bulk messages on voicemail devices, and if necessary to delete them automatically or register their senders in so-called blacklists of unsolicited subscribers. In addition, it is possible to extract keywords from messages by using a speech recognition system, or to identify synthetically generated messages by using a speaker recognition system.

For the mentioned measures, no distinction is made as to whether a message is an unsolicited bulk message or a solicited advertising message sent in large numbers. An advertising message that might have been solicited would thus be deleted without the affected subscriber having noted the contents of the advertising message. Given the existing defensive measures against bulk messages, it is therefore difficult for advertisers to send messages to interested recipients.

In the field of email spam, today there are already automated email production systems in use which change sender names or parts of the message. In addition, typographical errors are systematically introduced into particularly critical keywords which in fact negatively affect detection by the addressees, but which above all preclude detection by automated text analysis in particular. The option also exists to use HTML formatting to arrange text components on the display such that they can be read as coherent by the reader without being detectable as coherent in the HTML source text. In this manner, defensive measures can be at least partially circumvented.

In addition, texts prepared in advance are already being distributed today by telephone. At the same time, a part of the number called and the day of the week are typically included in the message by a voice messaging system in order to individualize them. However, such variations of spoken messages are reliably detected by the aforementioned systems, whereby it is difficult for advertisers to distribute messages reliably.

In addition, it is conceivable that a system for the production of bulk messages could be used as a test system for SPIT detection systems in order to thus improve the existing SPIT detection systems. Methods that ensure the distribution of messages sent in bulk despite the known detection systems would also be required for this application.

An object of the invention consists of designing a method and a device such that the production and distribution of messages directed to a multitude of recipients in a communications network is possible despite the existence of defensive measures against unsolicited bulk messages.

This object is achieved by a method and a device as provided in the independent claims. Developments of the invention are provided in the dependent claims.

The subject matter of the invention is a method for the production and distribution of messages directed at a multitude of recipients in a communications network, whereby a message to be transmitted is characterized by at least one semantic feature that defines the meaning of the contents of the message, and a number of formal features defined by the form of the message, and whereby a multitude of versions of the message to be sent are produced for this message, whereby each version of the messages differs to a certain extent with respect to the formal features from other versions of the message, and whereby each version of the message is sent to at least one recipient.

In addition, the invention relates to a device for the implementation of the method presented, as well as a corresponding communications network.

The invention carries with it the advantages that messages directed at a multitude of recipients can be produced and distributed by advertisers despite existing SPIT detection systems in the communications network, for example. In addition, it is conceivable that such a system could be used as a test system for SPIT detection systems.

### BRIEF DESCRIPTION OF THE DRAWINGS

Exemplary embodiments of the invention are show in the illustrations and are described below in greater detail, in which;

FIG. 1: shows a generator for the production of versions AN of a message N to be sent in accordance with variant 1.

FIG. 2: shows a generator for the production of versions AN of a message N to be sent in accordance with variant 2.

FIG. 3: shows a generator for the production of versions AN of a message N to be sent in accordance with variant 3.

FIG. 4: shows a generator for the production of versions AN of a message N to be sent in accordance with variant 4.

FIG. 5: shows a generator for the production of versions AN of a message N to be sent in accordance with variant 5.

FIG. 6: shows an additional generator for the production of versions AN of a message N to be sent in accordance with variant 5.

FIG. 7: shows a generator for the production of versions AN of a message N to be sent in accordance with variant 6.

### DETAILED DESCRIPTION OF INVENTION

The term “formal feature” is used below to mean that a message is characterized with respect to its form, which means with respect to its presentation in particular. Included here are acoustic and visual features in particular.

The term “semantic feature” is used below to mean a feature that characterizes the content of a message. The content of the message is characterized in particular by a communication that the recipient can perceive, which is transported by the message. The semantic feature of the message, which means its content, is independent of the formal features of the message, which means independent of the form and manner in which the communication is processed optically and acoustically, for example.

According to the invention, a message that is to be transmitted is characterized by at least one semantic feature that defines the meaning of the content of the message, and a number of formal features that define the form of the message. A multitude of versions of this message are produced for the message to be transmitted, whereby each version of the message differs to a certain degree from other versions of the message with respect to the formal features. Each version of the message is sent to at least one recipient in a VoIP communications network, for example.

The difference between two versions of the message can turn out to be more or less, depending on the method used to produce the versions. However, because the semantic meaning of the message, in other words the communication transmitted, remains unchanged in each case, each recipient perceives the same communication, despite receiving a version of the message that differs from all other versions of the message.

For all variants shown below for the production of versions of a message to be sent, the semantic feature of the message is described by a communication to be transmitted, in particular an acoustic speech information reproduced by means of the voice medium in particular, also referred to below as the speech portion. Speech is to be understood here as spoken and/or sung speech, which means speech reproduced melodically. The different versions of the message are sent to a multitude of recipients. At the same time, the versions of the message are produced in accordance with at least one of the variants presented below. A combination of the variants and/or individual features of the variants is conceivable.

Variant 1:

A different caller name as identified during the course of the message is used for each version of the message. After recording and saving a series of spoken first and last names, they can be recombined for each version of the message. At the same time, multiple first and last names can be combined, for example three first names and two last names combined as a compound name. A very large number of different name combinations can be produced in this manner. The transmitted communication is not changed by this measure, because the caller name is a feature that is simply unimportant for the communication. The semantics in the sense defined above are not thereby changed.

In addition, in each version of the message the volume of the caller's voice is variably modulated on the basis of an example, by repeatedly increasing and/or decreasing the volume of the caller's voice for example.

Variant 2:

The message includes an acoustic portion. This acoustic portion is superimposed with background sounds having high levels of impulsive sound. Recorded or artificially created pub or train station sounds which are recomposed and/or regenerated for each version of the message are suitable here for instance.

Variant 3:

A spoken portion included in the acoustic portion of the message includes individual words and/or sentences as well as pauses between these parts. The pauses are randomly varied with respect to their temporal duration.

Variant 4:

The spoken portion of the message is produced by means of synthetic speech production on the basis of a text file that contains, in written form, the communication to be transmitted. Each version of the message is produced with individualized caller characteristics (for example, with respect to fundamental frequency, formants, intonation, speed of speech, and so forth).

In addition, the caller characteristics can be changed from sentence to sentence and/or from word to word, whereby the change is made on the basis of an example. The example can be changed for each version of the message.

Variant 5:

The spoken portion of the message is produced by means of synthetic speech production on the basis of a text file that contains, in written form, the communication to be transmitted, whereby a melodic variation of the caller characteristics is used for the production of sung speech for each version of the message.

Variant 6:

Versions are produced for the message in the form of multimedia messages that contain an audio and video portion. An animated caller face moves in sync with the spoken portion of the message. At the same time, a different caller face can be used for each version of the message. In addition, a different background for the video portion can be selected for each version of the message. The background can also be created dynamically, using lighting effects and/or moving objects for example, in order to prevent automatic detection of the message as an advertising message.

Variant 7:

Versions are produced for the message in the form of multimedia messages that contain an audio and video portion. A video clip with cartoon character dance scenes can also be generated, whereby the video clip is in turn different from version to version of the message.

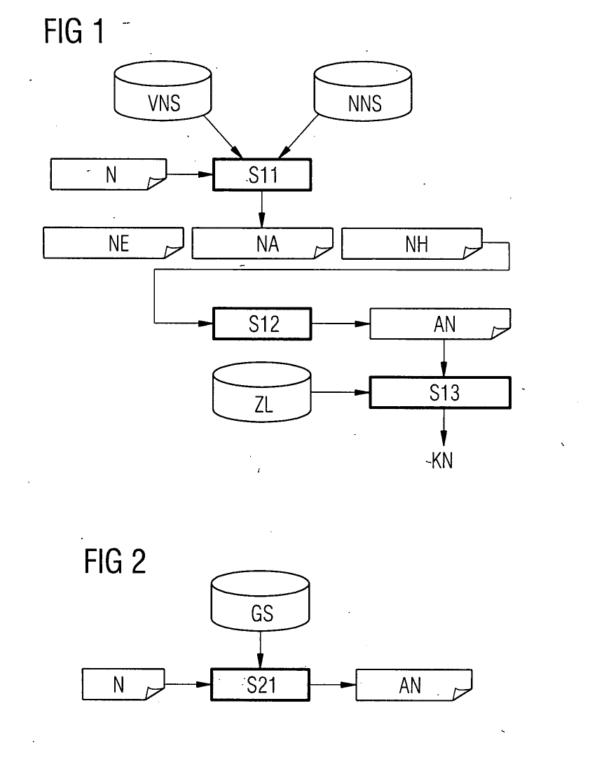

FIG. 1 shows variant 1 of a generator for the production of versions AN of a message N to be sent in accordance with variant 1. A version AN of the message is composed of a series of blocks NE, NA, NH (three block here as an example), which are partially prepared in advance (here, address/header NE and body NH of the message N), and partially produced by the described system (here, name information for the calling subscriber).

In a first step S11, the name information NA is compiled by means of a systematic or pseudo-random selection of first and last names from appropriate storage locations VNS, NNS. The example-based name selection NA provides for the selection of a sequence of first and last name, which are then included in at least one position in the version AN of the message N, and between message header NE and message body NH in the example shown.

In a second step S12, the volume of the compiled version AN of the message is modulated on the basis of a randomly produced example, and the new version AN of the message is thus produced.

The version AN of the message N is then sent in a third step S13 via a dispatch agent to a new telephone number or SIP address in a communications network, whereby the telephone number or SIP address is taken from the target number list ZL.

This third and final step S13 for sending the version AN of the message N is no longer shown separately in the following figures.

FIG. 2 shows variant 2 of a generator for the production of versions AN of a message N to be sent in accordance with variant 2. In a first step S21, the message N to be sent is mixed with random background sounds, whereby the background sounds are taken from sound storage GS. At the same time, it is advantageous if these background sounds have high levels of impulsive sound. The transmission of the version AN of the message corresponds to the procedure in accordance with FIG. 1.

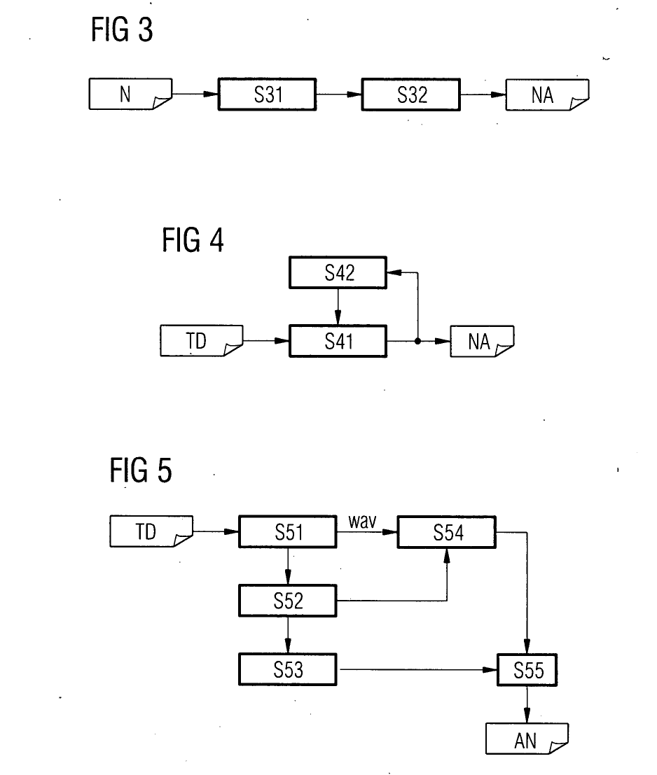

FIG. 3 shows variant 3 of a generator for the production of versions AN of a message N to be sent in accordance with variant 3.

In a first step S31, pauses are initially established automatically between words and/or sentences in the message N.

In a second step S32, these pauses are randomly extended in the version AN of the message N. These extensions can occur in the form of a pre-processing, for example by inserting gaps or background sounds, or by detecting pauses during a playback process, whereby the playback process is interrupted for a specific period in the case of a detected pause.

FIG. 4 shows variant 4 of a generator for the production of versions AN of a message N to be sent in accordance with variant 4.

The communication to be transmitted in the message N exists as a text file TD, which is converted into an audio file by means of a speech synthesis process in a first step S41.

At the same time, the parameters for this conversion are changed after each pause in speech in a second step S42 (after the conversion of a sentence or a word, for example). At the same time, the parameters include caller characteristics such as fundamental frequency, formants, intonation or speed of speech, for example. The first step S41 and the second step S42 are repeated until the text file TD is completely converted into an audio file.

FIG. 5 shows variant 5 of a generator for the production of versions AN of a message N to be sent in accordance with variant 5. As in variant 4, the communication to be transmitted in the message N exists as a text file TD.

In a first step S51, an audio message wav is generated from the text file TD using speech synthesis.

In a parallel step S52, a new musical composition is produced by a music generator. This musical composition is then advantageously available in the form of two midi files, with one file that includes the melody with harmonies, and one file that includes the accompaniment.

In a third step S53, the accompaniment is converted into an audio file using a midi expander.

In a fourth step S54, the melody and the audio file for the message are input into a vocoder (harmony creator, vocalist, vocalizer) that produces an audio file with one or more sung voices from the spoken text.

In a fifth step S55, the generated components are mixed with the audio file for the accompaniment. As in variant 4, it is possible to modify the caller characteristics, for example.

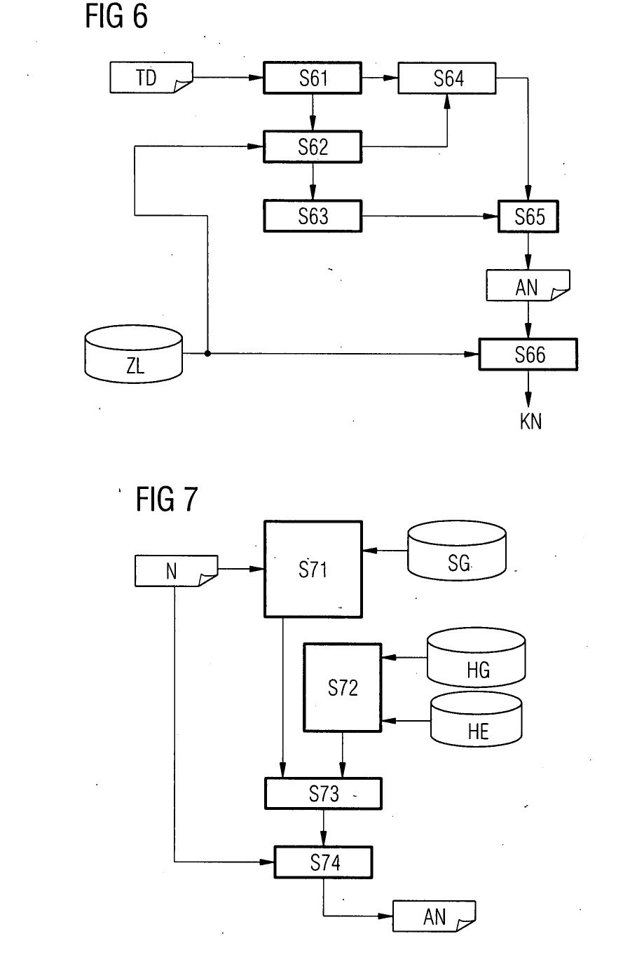

FIG. 6 shows an advantageous development of variant 5. The first five steps S61-S66 correspond to the first five steps S51-S55 from variant 5. In this development, the musical style can be individually controlled for each target subscriber, for example. For this purpose, in an additional sixth step S66 and prior to the dispatch of the version AN of the message N, a telephone number or SIP address is first taken from the target number list ZL, and the version AN of the message N is modified and sent in a manner appropriate to the selected subscriber.

FIG. 7 shows a generator for the production of versions AN of a message N to be sent in accordance with variant 6. The message N shown at the upper left can be available in the form of an audio file, for example, that is to be used for all versions AN of the message N, or it can already have been produced in accordance with one of the variants described above as a new version AN of the message N.

In a first step S71, the audio file is forwarded to a caller animation module that shows the caller face selected for the version AN of the message N from a certain perspective, and animates it with the spoken message.

The position of the caller in the image, and the zoom factor, can be changed repeatedly. These changes, as well as the selection of the caller face from a storage for caller faces SG, are to be different for each version AN of the message N, in order to make automatic detection of the same messages in storage systems difficult. The changes in caller position and zoom factor can also be integrated with collectively processed changes in perspective.

In parallel with the foreground film produced with the caller animation, in a second step S72 a background film can be produced, which consists of a randomly selected and/or dynamically modified background image taken from a background image storage HG, and optional additional background elements taken from a background element storage HE, which in turn can optionally move randomly.

In a third step S73, the foreground and background films can be combined and can be integrated in a fourth step S74 with the soundtrack into a new version AN of the message N.

With respect to variant 7, it allows the video clip to be controlled by means of midi data for the musical accompaniment from variant 5.

In an additional version of the invention, individual or multiple method steps can be implemented as software or hardware.

In an additional version of the invention, the music generator in accordance with variant 5 has multiple melody outputs that can create complex sets of voices when coupled with multiple speech generators.

In an additional version of the invention, the speech synthesis in accordance with variant 5 can be synchronized using the music generator.

In an additional version of the invention, the systems described in variants 5 and 7 can be used independently of the dispatch in order to produce new versions AN of a message N, which can then be compared in competitions. For this purpose, it is recommended that the parameters be changed not only randomly, but also that they are made manually adjustable.

In additional development stages, a system in accordance with variants 5, 6 or 7 could also form its own subculture in which particularly attractive versions AN of the messages N are picked up and forwarded. Finally, it is also conceivable that advertisers would pass along to the public a system in accordance with variant 5, and would hold competitions with respect to particularly successful and popular advertising messages.

In an additional version of the invention, the message N to be sent, as well as the versions AN of the message N, represent voice over IP messages that are sent into a voice over IP communications network.

The systems introduced are directed primarily at professional advertisers, but can also be used in botnets, for example. There, a high level of computing power is available for each message as a result of the parallel use of a large number of PCs. Alternatively, parts of the system can also be implemented in hardware.

1.-17. (canceled)

18. A method for the production and distribution of messages directed at a multitude of recipients in a communications network, comprising:
producing a plurality of versions of a message, each version to be transmitted, the message includes a semantic feature that defines the content of the meaning of the message, and a plurality of formal features that define the form of the message;
differing each version of the message with respect to the formal features; and
sending each version of the message to a recipient.

19. The method as claimed in claim 18, wherein the message includes acoustic speech information reproduced by a voice medium.

20. The method as claimed in claim 19, wherein the message is for advertising purposes.

21. The method as claimed in claim 19, wherein the speech information is generated by speech synthesis based on a text file.

22. The method as claimed in claim 21, wherein the speech information is assigned modifiable caller characteristics.

23. The method as claimed in claim 22,
wherein the caller characteristics for a version of the message, in particular with respect to fundamental frequency, formants, intonation or speed of speech, are changed from sentence to sentence and from word to word of the spoken information, or
wherein the caller characteristics for a version of the message, in particular with respect to fundamental frequency, formants, intonation or speed of speech, are changed from sentence to sentence or from word to word of the spoken information,
wherein the change in each version of the message occurs on the basis of a changeable example.

24. The method as claimed in claim 19, wherein the speech information is spoken in advance by a human caller and stored for further use

25. The method as claimed in claim 24, wherein the speech information is assigned modifiable caller characteristics.

26. The method as claimed in claim 25,
wherein the caller characteristics for a version of the message, in particular with respect to fundamental frequency, formants, intonation or speed of speech, are changed from sentence to sentence and from word to word of the spoken information, or
wherein the caller characteristics for a version of the message, in particular with respect to fundamental frequency, formants, intonation or speed of speech, are changed from sentence to sentence or from word to word of the spoken information,
wherein the change in each version of the message occurs on the basis of a changeable example.

27. The method as claimed in claim 18, wherein a version of the message is provided with a background selected from the group consisting of background sound, background noise, background music with impulsive sound and combinations thereof,
wherein the background is changed for each version of the message.

28. The method as claimed in claim 18, wherein a version of the message is provided with a background selected from the group consisting of background sound, background noise, background music with impulsive sound and combinations thereof,
wherein the background is reproduced for each version of the message.

29. The method as claimed in claim 19,
wherein random delays are inserted between individual words and sentences of the speech information of a version of the message or
wherein random delays are inserted between individual words or sentences of the speech information of a version of the message.

30. The method as claimed in claim 19, wherein the speech information is varied with different combinations of key words.

31. The method as claimed in claim 19, wherein the speech information is varied with different combinations of first names and last names from a store of first names and a store of last names.

32. The method as claimed in claim 19, wherein for each version of the message the caller volume for the spoken message is modulated with a varying example.

33. The method as claimed in claim 19,
wherein the speech information is generated by a song synthesis based on a text file, and
wherein an underlying melody is changed in each version of the message.

34. The method as claimed in claim 18,
wherein the message includes a video portion, and
wherein the video portion is changed for each version of the message.

35. The method as claimed in claim 18, wherein a version of the message represents a voice over IP message for dispatch in a voice over IP communications network.

36. A device for the production and distribution of messages directed at a multitude of recipients in a communications network, comprising:
a message to be transmitted is characterized by at least one semantic feature that defines the meaning of the content of the message, and a number of formal features that define the form of the message;
a version creator for producing a plurality of versions of the message to be transmitted, wherein each version of the message differs to a certain extent from other versions of the message with respect to the formal features; and
a transmitter for sending each version of the message to a recipient in the communications network.

37. A communications network, comprising:
a device for the production and distribution of messages directed at a multitude of recipients in a communications network, comprising:
a message to be transmitted is characterized by at least one semantic feature that defines the meaning of the content of the message, and a number of formal features that define the form of the message;
a version creator for producing a plurality of versions of the message to be transmitted, wherein each version of the message differs to a certain extent from other versions of the message with respect to the formal features; and
a transmitter for sending each version of the message to a recipient in the communications network.
